(19) United States
(12) Patent Application Publication
(10) Pub. No.: US 2003/0065806 A1
(43) Pub. Date: Apr. 3, 2003

(54) Audio and/or visual system, method and components

(75) Inventors: Graham G. Thomason, Redhill (GB); Armando S. Valdes, Orpington (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/242,932

(22) Filed: Sep. 13, 2002

(30) Foreign Application Priority Data
Sep. 28, 2001 (GB) 0123349.3

(51) Int. Cl. G06F 15/16

(52) U.S. Cl. 709/231

(57) ABSTRACT

A system has source devices (2, 4) for supplying audio and/or visual data and resource devices (6) for outputting audio and/or visual data. When a source device (2, 4) is activated, the source device connects to suitable resource device (6), by determining suitable available resource devices, for example by polling the air, and simply connecting to the suitable resource device or devices. The user can switch off unwanted resource devices and select suitable data in the event that one of the resource devices receives a plurality of data streams (18, 20).

This invention relates to a network system for displaying audio and/or visual information, and in particular to a system that may be useful for interconnecting sources of audio and/or visual data such as computers or video recorders with output systems such as projectors.

Prior art systems for the display of audio and/or visual data, for example to display presentations stored on a laptop or video data from a video recorder typically employ any of a number of different display or replay devices, for example including a television, a sound system and/or a projector projecting images onto a screen. A number of wires may connect the data source to the projector.

A problem in such prior art systems is that there are often a large number of possible sources of data and display components. For example, an individual presenter may bring a laptop with a presentation stored thereon. A conference room may also have a video recorder, DVD player, tape recorder, a local computer connected to a local network, and any number of alternative information sources. These may be connected to display or output apparatus such as projectors, audio systems, personal computers or television screens in a haphazard manner. The selection may be carried out by plugging individual wires into various data sockets on the display or output apparatus, selecting between different inputs using buttons, for example by selecting a tape input or a CD input on a sound system, or by using a desktop conference room controller to select the required video source.

Such prior arrangements have a number of problems. It is common for nothing to be displayed on desired display apparatus, such as a projector, for a number of reasons. For example, it is easy to select the wrong input on the projector or the wrong connector, a controller may have switched the projector into standby mode, or the system may simply be wired together incorrectly.

Since users of conference rooms, lecture theatres and other locations where audio, visual or audiovisual presentations are given only seldom understand how a given system is connected together, it can be very difficult to diagnose what is causing the failure to project the required information. This problem is exacerbated by the need to connect any of a number of components to a projector or other display apparatus, which may require removing existing connections and replacing them with other connections thus increasing the confusion. Carefully arranged projector set-ups can in this way easily be destroyed.

Accordingly, it would be desirable to automate this process in order that projection or display can be reliably achieved in as easy a fashion as possible.

According to the invention, there is provided a system comprising: a plurality of devices including respective communications interfaces for communicating between the plurality of devices; wherein at least one of the devices is a source device including a source of audio and/or visual content and a control for activating the source to supply a data stream representing audio and/or visual content; at least one of the devices has a resource for outputting audio and/or visual content; and the at least one source device is adapted, when a source of audio and/or visual content outputting a data stream is activated, to determine the resource or resources required to output the data stream and the resources available on other devices, to make a connection to a device or connections to other devices having the resources to output the audio and/or visual content required by the activated source of audio and/or visual content and to supply at least part of the data stream through the connection or connections for output.

Thus, according to the invention, when a source of audio and/or visual content is activated the source makes the necessary connection to enable the source material to be displayed. The user need not trouble himself with making source selections himself, since the system is automatically configured to deliver the data stream to suitable output devices. Further, the communications link is formed when the source requires to output data. There is no need for the overhead of maintaining a full network connection from devices that do not require communications links at any given time.

The source device preferably polls the air to determine other available devices to avoid the need for maintaining all available display devices and source devices in a network configuration. In other words, the source device may output a polling request through the communications interface and through the air using electromagnetic radiation, for example by radio, light or infra-red radiation. Responses to the polling requests are processed by the source device to determine suitable output devices. This reduces network overhead.

It is also possible to connect all available devices together as a network, for example placing inactive devices into a parked or inactive mode to reduce network overhead.

Preferably, the source device includes a memory for storing a list of devices having play or storage capability. The source device may poll the air to determine which other devices are available and the type of their display or storage resources and may create a list of these devices and resources in the memory.

Conveniently, the system uses one or more Bluetooth piconets to make the connection or connections between two or more devices.

The joining procedure differs from a conventional Bluetooth inquiry procedure. Conventional Bluetooth is device-oriented, i.e. it causes connections between devices based on properties of the devices. In a system according to the invention, however, the forming of a connection may be triggered, not simply by bringing devices into range, but when a source of audio and/or visual content outputting a datastream is activated. Nevertheless, it is still possible to use Bluetooth transceivers to form the required connections.

The invention also relates to a source device, comprising at least one audio and/or visual data source that may be activated to provide a datastream representing audio and/or visual content; a communications interface for connecting the audio and/or visual device to other devices including devices having audio and/or visual play or storage capabilities; and code for determining, when a source of audio and/or visual content is activated, the play capabilities required by the source of audio and/or visual content, determining which other available devices have the required play capabilities, making a connection through the communications interface with the other device or the other devices having required play capabilities, and providing at least part of the datastream representing audio and/or visual content to the other device or devices via the connection.

Preferably, the source device includes code for polling the air to determine other devices available and their play capability.

In embodiments the source device may include a store for storing a server capability list of other devices available and their play capabilities, and code for polling the network through the connection to determine other devices available and their play capabilities, and to store this information in the server capability list. In this way, the audio and/or visual device always has available a list of suitable output devices.

The audio and/or visual device may further contain code to disconnect the connection when the source of audio and/or visual content is deactivated. In this way, only the necessary connections are made at any one time. Alternatively, the connection may be simply put into a dormant state.

As well as using the server capability list to store the possibilities for data output of other available devices, the list may also contain details of the data available from those other devices. The audio and/or visual device may thus further include an application requiring data input, and code for determining, when the application requiring data input is started, another device or devices connected through the network having the capability to supply the data, and to make a network connection with the other device or devices.

The invention also relates to an output device comprising: at least one output component for playing audio and/or visual information; a communications interface for connecting to other devices through a network; a polling response module for responding to polling requests received through the communications interface with information regarding the play capabilities of the output device; and code for making a connection or connections with another device or other devices for receiving an audio and/or visual data stream or streams, the or each connection being made when requested by the or each other device, for playing the audio and/or visual data stream when a single data stream is received, and, when a plurality of data streams are received, for playing each of the plurality of data streams in parallel.

The audiovisual device may be a projector and the user selection device a remote control. This makes the device very easy to use without the need to make separate connections.

The projector may simply display all of the data streams that it receives until the user selects one of those data streams. Alternatively, rather than showing a plurality of output data streams on the audiovisual device, the audiovisual device may simply provide an indication of the source, for example a name of the source device, and allow the user to toggle between the source devices.

The remote control may include a display for displaying each of the received data streams regardless of the selected data stream displayed on the audio and/or visual component. This facilitates selection of the required data stream. The plurality of data streams may be displayed in a tiled image on the projector or on the remote control or both.

Instead of a projector, the audio and/or visual device may be a computer having input interface such as a keyboard, a processor and a computer display as the audio and/or visual output component. Many other forms of audio and/or visual device are also possible, including by way of example a sound system, television, or a combined “home” cinema system. It should in this connection be noted that “audio and/or visual” is used to refer to audio, images, whether moving or stationary, and/or any combination of these.

The invention also relates to an output method for use with a plurality of devices, including: activating a source of audiovisual content in one device, the source of audiovisual content requiring certain play capabilities, determining the play capabilities required, determining which of the other devices available have the required play capabilities, making a connection through a communications interface with the other device or the other devices having required play capabilities, supplying at least part of the data stream through the connection to the other device or other devices having required play capabilities; and outputting the data stream on the other device or devices.

For a better understanding of the invention, embodiments will now be described, purely by way of example, with reference to the accompanying drawings in which:

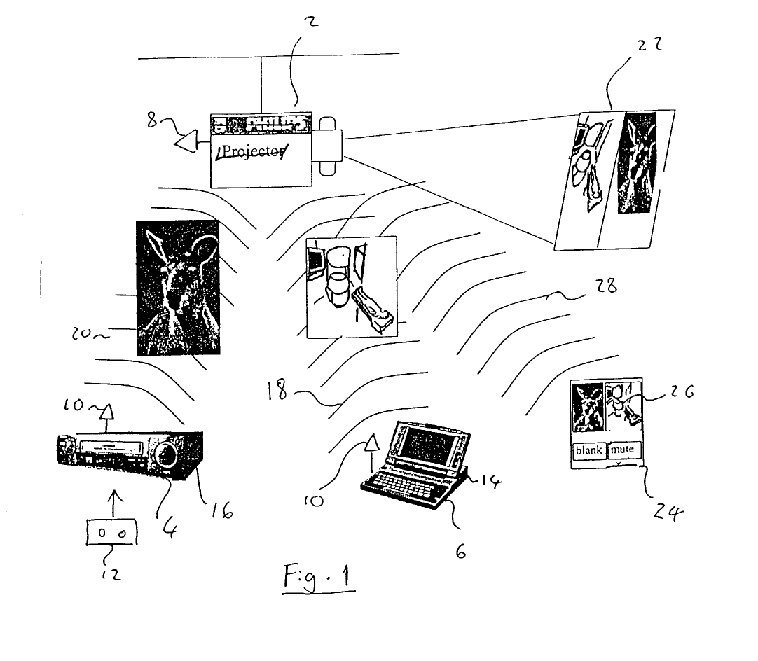

FIG. 1 shows a first embodiment of a system according to the invention;

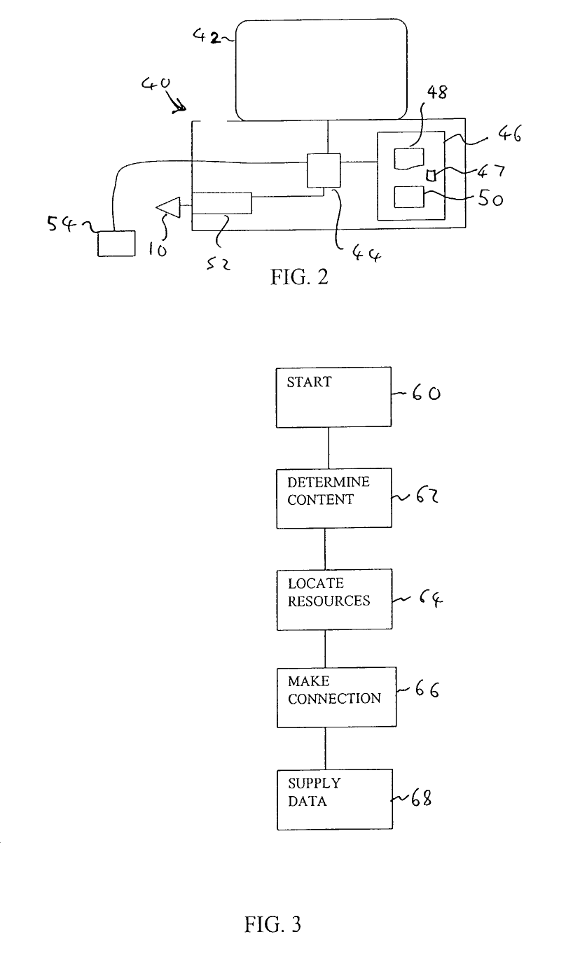

FIG. 2 is a block diagram of an audio and/or visual device acting as a data source;

FIG. 3 is a flow diagram of the operation of the device of FIG. 2; and

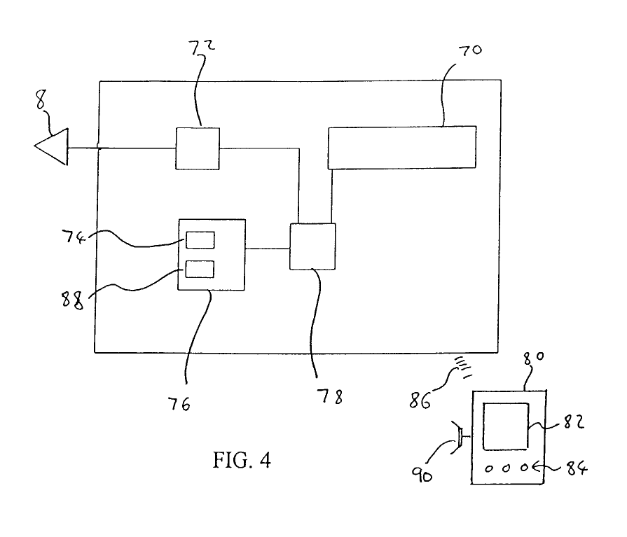

FIG. 4 is a block diagram of a display device.

Like components are generally given the same reference numerals in the different figures. It should be noted that all of the Figures are schematic and not to scale.

Referring to FIG. 1, a system includes a projector 2, a video recorder 4, and a laptop computer 6. Each of these are located in the same location within range of a Bluetooth beacon 8. The projector 2 acts as a play or output device for playing audio and/or visual information, here visual information, whereas the video recorder 4 and laptop computer 6 act as sources of audio and visual information. Audiovisual data is stored on video cassette 12 and in memory 14 in the lap top.

The projector 2 has a Bluetooth transceiver or beacon 8 and the video recorder 4 and laptop 6 are provided with Bluetooth transceivers 10. The projector 2 has a remote control 24 with screen 26 and projects onto display screen 22. Further details of the source and play devices will be presented below.

As an example of the system in use, suppose that a wildlife video is stored on a tape 12 and inserted in the video recorder 4, and a slide show is stored in memory 14 on the laptop 6.

When the user of the laptop 6 wishes to make a presentation, the user starts suitable software on the laptop 6 which causes the laptop 6 to determine that it needs to locate suitable display resources. The laptop 6 accordingly makes a network connection to the projector 2 and supplies a data stream 18 of image data through the network connection to the projector 2. Suppose that the video recorder has also been started by pressing the “play” button 16 which functions as a control for starting an audiovisual datastream. The video recorder likewise requires display resources and accordingly likewise makes a connection to the projector 2 and sends a data stream 20 to the projector. The projector thus receives two data streams 18, 20 from the laptop 6 and the video recorder 4 respectively, and simply displays both of those data streams on a projection screen 22. In order that the presentation can continue with only one image on the screen, the user takes the remote control 24 which has a remote control display 26 displaying images from each of the data streams 18, 20, and selects the presentation of the medical equipment (data stream 18). The remote control then sends a signal 28 to the projector to cause it to display only this one presentation on the screen 22. Both data streams remain displayed on the remote control display 26 to enable the other data stream 20 to be selected if required.

As an alternative, when the projector receives more than one data stream the projector can display on the screen 22 not the two data streams themselves but an indication of the streams, such as a single frame from the data stream or even a label, title, or similar indication of the streams.

When the presentation finishes, the data stream 18 is stopped and the projector then returns to displaying the images from the video recorder 4 received on data stream 20.

The slides simply use a single projector to display the data stream 18. However, other applications may provide audio output, video outputs, or other types of multimedia output. The laptop 6 can be arranged to make automatic connection with other output components having resources to handle audio and/or visual content, such as an amplifier/loudspeaker combination, a surround sound processor, a projection television set, and/or whatever is required to output the data stream produced by the application.

It is not a problem if the data stream is displayed or output on a number of different devices, in the event that more than one available device is capable of displaying the data. The user can simply switch off or disconnect those output devices that are not required. The system is accordingly generally although not exclusively intended for use on local connection systems rather than company-wide, national or international networks.

A Bluetooth piconet is accordingly a very suitable connection, since it operates over short range. However, as well as the use of a Bluetooth piconet involving beacon 8, other communications links such as infra-red, direct wireless (radio) links or wired networking may be used instead.

Referring to FIG. 2, an audio and/or visual source device 40 for supplying data will now be described in more detail. The device 40 includes a computer screen 42, computer processor 44 and memory 46. The memory 46 includes code 48 which will be described later, and is also used for storing a list 50 of other devices on the network. The memory also includes audiovisual data 47. A Bluetooth interface module 52 is also provided for making a connection to Bluetooth transceiver 10. In other embodiments, the Bluetooth interface module may be replaced by other forms of interface module, such as a modem, network card or the like.

The device 40 also includes an input device 54. This may be a conventional computer keyboard, a touch pad, a mouse, or a tracker pad, or simply an on/off switch or play button depending on the type of device 40. For example, if the device 40 is a PDA, the input device 54 may be a touch pad.

The input device 54 constitutes a control for activating the source of audio-visual content. In alternative embodiments other controls for activating the source of audio-visual content may be used, such as switches, or software or hardware that triggers the audiovisual content in predetermined circumstances.

The code 48 is arranged to cause the device 40 to carry out the necessary operations to display audio and/or visual data stored in memory 46. The flow diagram of FIG. 3 illustrates the steps carried out. Initially, (step 60) the audio and/or visual content is activated by the input 54. This may be done by starting an application program, pressing a play button, or any other way of starting audio and/or visual display as will be well known to the skilled person.

When the audiovisual content is activated, the capabilities required to display the audio and/or visual content are determined (step 62) and it is further determined (step 64) which other devices connected through network interface 52 can provide those resources. The determination is made, in an embodiment, by polling the air. To poll the air, a signal is transmitted through the air from the source device, generally a radio signal, though embodiments may use an optical signal. Any device receiving the signal may respond by sending a signal indicating an ID for the device and the available output/storage capabilities, and these signals are received and processed by the source device.

A connection to those devices having the required or appropriate resources is then made in step 66, following which the output information is supplied as a data stream to those resources (step 68).

This approach avoids any need for a permanent network connection to be maintained between all devices.

FIG. 4 illustrates an output device, in this case a projector capable of displaying input data. The projector includes an audio and/or visual component 70, in this case a conventional projection unit for projecting onto a screen 22 (FIG. 1). The projection unit thus constitutes a resource for displaying audio and/or visual content, here visual images. The projector also includes an interface 72, for connecting to other devices via bluetooth beacon 8. A module 74 is responsible for responding to polling requests received through the interface 72 with information regarding the play capabilities of the device, i.e. of the projection unit resource 70. The polling response module 74 may conveniently be implemented as code 74 stored in memory 76 within the projector in cooperation with a data processor 78. A user selection device 80, here a remote control with a separate display 82 and selection buttons 84 is in communication with the projector through link 86.

The memory 76 also contains code 88 for making a connection with other devices when requested by other devices, and for replaying audio and/or visual data streams received by those other devices through the interface 72. When the projector receives a plurality of data streams, the code causes each of these to be displayed in parallel on the projection element 70 until a suitable selection input is received across link 86 from the remote control 80 to select one or more of the received data streams.

It will be appreciated that the form of display and the remote control are not critical, and instead of a conventional projector, a large computer screen or other display device may be used. Similarly, the remote control 80 may be replaced by another user selection device such as a switch in communication with the projector.

Consider the case that the laptop 6 of FIG. 1 is a source device 40 according to FIG. 2. When a slide show is started on source device 40, the device 40 automatically broadcasts a unique ID for the device 40, data for the display, together with any associated audio. The projector 2 then accepts the device into a local network to connect source 40 and projector 2.

The local network may be a Bluetooth piconet. The projector 2 then displays the slide show. When the slide show is closed down, the device 40 disconnects itself from the local network and the projector 2 stops displaying the data.

Similarly, when the VCR 6 is started, it too transmits its ID and the audio/video data and connects to the piconet. When it is stopped, it disconnects itself from the piconet, and again the projector stops displaying the signal.

Note that there is a difference here to a conventional Bluetooth approach. In a conventional Bluetooth network, when a device sends a Bluetooth inquiry signal it may form a piconet with itself as master and any or all responding Bluetooth devices as slaves. However, if there is more that one source device then this would result in each source device setting up a separate piconet with itself as master. Thus each of the communications links 18, 20 would be a separate Bluetooth piconet, each controlled by the respective source device. The difficulty is that by default a Bluetooth transceiver 8 can only actively participate in one piconet at a time, so it would be difficult to receive two or more data streams 18,20 in the display device 2 simultaneously.

Accordingly, it is preferred to set up a single piconet with the play device 2 as master. When adding additional source components 6 to the piconet, the source component sends a Bluetooth inquiry signal and the play device 2 responds with an indication of resources available. The new source device 6 forms a new piconet with itself as master. If the play device 2 is not already present in a piconet, the master and slave can simply be swapped. Alternatively, if the play device 2 is already present and master of a preexisting piconet, the new piconet can simply be used to instruct the play device to add the new source device 6 to the existing piconet. After the instruction is transmitted, the new piconet can be closed down and the play device 2 can then add the new source device 6 to the existing piconet in the usual way.

It is possible that a source device 4, 6 may be present in two piconets to deliver a datastream to two play devices by time slicing. Alternatively, one device 6 may act as a master for a single piconet including all active source and play devices 2, 4, 6. A further approach is to provide devices with multiple Bluetooth transceivers to allow devices to be present in multiple networks.

If the projector receives more than one signal, by default it shows them all. The projector can then be forced to show just a signal required, for example by disconnecting or stopping all unwanted signals. Alternatively, this can be selected on user selection device 80.

The remote control 80 may conveniently be provided with an audio transducer 90 which can emit audio tones where the projector 2 receives a new signal. This allows the remote control to be more easily located.

In addition to data output, if any devices in the network start any input-output operation, the device may be suitably connected. For example, if a device in communication with beacon 8 starts sound recording, the sound may be recorded over the network, not the air. This enables it to obtain high quality original sound data rather than poor quality data that would arise from recording with a local microphone.

One possible application of the technology is for a Consultant at a hospital to become networked to pick up a Radiologist's real time image of a patient in order to provide suitable advice over the data network.

From reading the present disclosure, other variations and modifications will be apparent to persons skilled in the art. Such variations and modifications may involve equivalent and other features which are already known in the design, manufacture and use of networked audio/video devices and which may be used in addition to or instead of features described herein.

1. A system comprising:
a plurality of devices including respective communications interfaces for communicating between the plurality of devices; wherein
at least one of the devices is a source device including a source of audio and/or visual content and a control for activating the source to supply a data stream representing audio and/or visual content;
at least one of the devices has a resource for outputting audio and/or visual content; and
the at least one source device is adapted, when a source of audio and/or visual content outputting a data stream is activated, to determine the resource or resources required to output the data stream and the resources available on other devices, to make a connection to a device or connections to other devices having the resources to output the audio and/or visual content required by the activated source of audio and/or visual content and to supply at least part of the data stream through the connection or connections for output.

2. A system according to claim 1 wherein the at least one device including a source of audio and/or visual content is adapted to determine the resources available on other devices by transmitting a polling signal through the air and receiving response signals from other devices to determine other available devices and their available resources.

3. A system according to claim 1 wherein the or each source device further comprises:
a memory for storing a list of devices having play or storage capability; and
code for causing the system to poll other devices through the communications interface to determine devices having display or storage resources and the type of those resources and to create a list of the devices and corresponding resources within the device.

4. A system according to claim 1, wherein the connection is by means of a Bluetooth piconet.

5. A source device, comprising
at least one audio and/or visual data source that may be activated to provide a datastream representing audio and/or visual content;
a communications interface for connecting the audio and/or visual device to other devices including devices having audio and/or visual data handling capabilities;
and code for determining, when a source of audio and/or visual content is activated, the output capabilities required to output the source of audio and/or visual content, determining which other available devices have the required output capabilities, making a connection through the communications interface with the other device or the other devices having required output capabilities, and providing at least part of the datastream representing audio and/or visual content to the other device or devices via the connection.

6. A source device according to claim 5 wherein the code determines other available devices by polling the air to determine the available play capabilities of other devices.

7. A source device according to claim 5 further comprising a store for storing a server capability list of other devices available and their play capabilities;
and code for polling to determine other available devices and their play capabilities; and for storing this information in the server capability list.

8. A source device according to claim 5 further comprising code for disconnecting the audio and/or visual source device from other devices when the audio and/or visual data source no longer provides a datastream representing audio and/or visual content.

9. A source device according to claim 5 in the form of a computer further comprising:
a computer input interface; and
a computer processor.

10. An output device comprising:
at least one output component for playing audio and/or visual information;
a communications interface for connecting to other devices through a network;
a polling response module for responding to polling requests received through the communications interface with information regarding the play capabilities of the output device; and
code for making a connection or connections with another device or other devices for receiving an audio and/or visual data stream or streams, the or each connection being made when requested by the or each other device, for playing the audio and/or visual data stream when a single data stream is received, and, when a plurality of data streams are received, for playing each of the plurality of data streams in parallel.

11. An output device according to claim 10 further comprising a user selection device for selecting one or more of the received data streams, and code for outputting, following selection of one or more data streams, only the selected data stream or streams on the audio and/or visual component.

12. An output device according to claim 11 wherein the user selection device is a remote control.

13. An output device according to claim 12 wherein the remote control includes a display and each of the received data streams are displayed on the remote control for selection independently of whether the plurality of data streams or only one of the data streams are played on the output component.

14. An output device according to claim 12 wherein when a plurality of data streams are received the audio and/or visual output component displays a tiled image including data from each of the data streams.

15. An audio and/or visual device according to claim 10, further comprising
an application requiring data input;
and code for determining, when the application requiring data input is started, another device or other devices connected through the network having the capability to supply the data and making a connection with the other device or devices.

16. An output method for use with a plurality of devices, including:
activating a source of audio and/or visual content in one device, the source of audio and/or visual content requiring certain play capabilities,
determining the play capabilities required,
determining which of the other devices available have the required play capabilities,
making a connection through a communications interface with the other device or the other devices having required play capabilities,
supplying at least part of the data stream through the connection to the other device or other devices having required play capabilities; and
outputting the data stream on the other device or devices.

17. An output method according to claim 16, wherein the step of determining other available devices includes polling the air to determine other available devices and their capabilities.

18. An output method according to claim 16 wherein the device or devices having a source of audio and/or visual content include a memory for storing a list of devices having play or storage capability, the method further comprising:
polling to determine devices having display or storage resources and the type of those resources and
creating a list of the devices and corresponding resources within the device.

19. An output method according to claim 16 wherein one of the devices is a projector having a user selection device, wherein
when the projector receives a plurality of data streams for projection, the projector initially displays each of the plurality of data streams in parallel;
until a selection input on the user selection device is received to select one or more of the received data streams, whereafter the projector displays that data stream.
